(19) United States
(12) Patent Application Publication
(10) Pub. No.: US 2008/0193592 A1
(43) Pub. Date: Aug. 14, 2008

(54) Method for preparing alcoholic beverage using incubated wild ginseng root

(75) Inventor: Deok Su Chang, Cheongju-si (KR)

Correspondence Address: GREER, BURNS & CRAIN, 300 S WACKER DR, 25TH FLOOR, CHICAGO, IL, 60606, US

(73) Assignee: Chungbuk Soju Co., Ltd., Cheongwon-gun (KR)

(21) Appl. No.: 12/012,857

(22) Filed: Feb. 6, 2008

(30) Foreign Application Priority Data
Feb. 12, 2007 (KR) 10-2007-0014455
Feb. 12, 2007 (KR) 10-2007-0014464
Feb. 13, 2007 (KR) 10-2007-0014755

(51) Int. Cl. C12C 11/00; C12G 3/00

(52) U.S. Cl. 426/11; 426/592

(57) ABSTRACT

The present invention relates to a method of preparing alcoholic beverages using incubated wild ginseng root. Specifically, the present invention relates to a method of preparing alcoholic beverages comprising incubated wild ginseng root, characterized in that it comprises a step of introducing the incubated wild ginseng root in an amount of 0.5-5 wt % during bottling process, followed by capping, and alcoholic beverages comprising incubated wild ginseng root which is produced by said method.

### DETAILED DESCRIPTION OF THE INVENTION

1. Field of the Invention

The present invention relates to a method of preparing alcoholic beverages using incubated wild ginseng root. Specifically, the present invention relates to a method of preparing alcoholic beverages comprising incubated wild ginseng root, characterized in that it comprises a step of introducing the incubated wild ginseng root in an amount of 0.5-5 wt % during bottling process, followed by capping, and alcoholic beverages comprising incubated wild ginseng root which is produced by said method.

2. Description of the Related Art

Moderate consumption of alcoholic beverages is advantageous in that it can relieve stress, promote sleep, digestion and body metabolism and improve social relationship. On the other hand, when it is over-consumed, undegraded alcohols convert to toxic acetaldehyde, some times resulting in hangover such as headache and stomach pain, etc. Recently, in order to relieve such hangover, functional alcoholic beverages having various characteristics are being developed, including those comprising additives such as Japanese apricot, green tea or wild-berry, etc.

Ginseng has been long known for it remarkable effect of treating various disorders and restoring body stamina. In order to study such pharmaceutical effect of ginseng, a broad range of studies is currently in progress. Especially, compared to cultivated ginseng, wild ginseng is known to have more kinds and/or amounts of components that are beneficial to human body. According to a quantitative analysis using high performance liquid chromatography (HPLC), it is found that the wild ginseng shows more special peaks that have not been known for the cultivated ginseng. Wild ginseng is a very rare plant so that is was called “magic plant” in Dongui Bogam, an ancient Korean medicine book. Its main components are saponin, polyacetylene compounds, polyphenol compounds, acidic polysaccharides, and other general components. Pharmaceutical efficacy of wild ginseng includes, anti-cancer activity, anti-oxidation activity, cholesterol-lowering activity, inhibitory effect on cancer cell proliferation, anti-platelet activity (strengthening a heart function and improving blood flow), inhibitory effect on aging, improvement of immunologic function, strengthening weak body, anti-diabetic effect, stress-relieving effect, whitening effect and other clinical effect, sexual function improving effect, and significant effect of treating neuralgia, thyroid disorder, insomnia and dermatitis, etc. Thanks to the recent development in biological engineering technology, mass-production of incubated wild ginseng root comprising ginsenosides, which is a physiologically active substance of ginseng, becomes possible. Consequently, from wild ginseng, incubated wild ginseng root can be obtained by processes comprising induction of adventitious root, line selection, incubation in a bioreactor, mass-incubation in plant, harvest and drying.

Wild ginseng, which has been called ‘eternal youth herb’ since ancient times, is known for its various remarkable effect. Especially, it is believed that various types and amounts of components that are not comprised in cultivated ginseng are present in wild ginseng. Thus, it is known that the wild ginseng is effective for improving a resistance to overcome fatal diseases.

Inventors of the present invention have already succeeded in providing wild ginseng in callus form based on incubation of wild ginseng cell using cell culture technique, in accordance with co-work with CBN Biotech (Center for Research and Development of Advanced Horticultural Technology, Chungbuk National University). In addition, as it has been described in Korean Patent Registration Publication No. 0353636, inventors of the present invention have already succeeded in incubating single cell originating from said callus to differentiate it into organs of the wild ginseng, and therefore hold a technology for mass-production of adventitious root of ginseng, panax ginseng, and wild ginseng based on said culture technology which allows public use and study of wild ginseng.

Incubated wild ginseng root, having the same genetic composition and even better efficacy than wild ginseng, can be a life-saving herbal medicine for modern people, as containing saponin in an amount several tens or more than that comprised in cultivated ginseng. Thanks to the recent development in biological engineering technology, mass-production of incubated wild-ginseng root comprising an increased amount of ginsenosides, which is a physiologically active substance of ginseng, becomes possible. Consequently, from wild ginseng, incubated wild ginseng root can be obtained by processes comprising induction of adventitious root, line selection, incubation in a bioreactor, mass-incubation at the level of pilot plant, harvest and drying.

There are various kinds of liquors. According to manufacturing process, they are categorized into fermented liquor, distilled liquor and compounded liquor. Fermented liquor is based on fermentation process by microorganisms, consuming sugar and starch included in fruits, grains and others. It has a special flavor and smooth taste coming from said raw materials and includes fruit liquor such as grape wine, beer, rice liquor, unrefined rice liquor and rice wine. Distilled liquor is obtained by distillation of previously fermented liquor or liquor mash, which allows a removal of impurities, and includes whiskey, brandy, vodka, rum and tequila, etc. Compounded liquor is prepared by adding fruits, flavors, sweeteners, or herbs, etc. to fermented liquor or distilled liquor, followed by extraction or distillation. Various cocktails belong to compounded liquor.

However, conventional alcoholic beverages are sometimes inappropriate for drinking as having unpleasant smell and taste that are unique to them. In addition, they may cause a hangover problem and thus often rejected by people who dislike the taste originating from some additives. In other words, having coarse flavor and taste and hangover-inducing problem, conventional alcoholic beverages are not so widely enjoyed by people of all ages.

### TECHNICAL SUBJECT TO BE ACHIEVED BY THE INVENTION

Therefore, the present invention provides a method for producing functional alcoholic beverages by using incubated wild ginseng root. Specifically, it relates to the method for producing functional alcoholic beverages by using incubated wild ginseng root wherein the incubated wild ginseng root is added to the liquor after it has been optimized to achieve an extraction of its effective components and to obtain favored balance between the taste and flavor. As such, technical object of the present invention is to establish a method for producing functional alcoholic beverages comprising incubated wild ginseng root, while maintaining those deep taste and flavor unique to the wild ginseng root, and inhibiting unpleasant taste and flavor of the liquor but still having a nice harmony with such flavor.

### CONSTITUTION OF THE INVENTION

In order to achieve the above-described purpose of the invention, the present invention provides a method of preparing alcoholic beverages using incubated wild ginseng root. More specifically, the present invention provides a method of preparing alcoholic beverages comprising incubated wild ginseng root, characterized in that it comprises a step of adding the incubated wild ginseng root in an amount of 0.5-5 wt % during bottling process, followed by capping. Preferably, said incubated wild ginseng root can be added in an amount of 2-3 wt % during bottling process.

According to one embodiment of the present invention, the present invention provides a method of preparing alcoholic beverages comprising incubated wild ginseng root, characterized in that it comprises a step of adding the incubated wild ginseng root during bottling process in an amount of 0.5-5 wt % to fruit liquor that has been prepared by natural fermentation of fruits or by extraction of fruits with alcoholic beverages, followed by capping. Specifically, the present invention provides a method of preparing alcoholic beverages comprising incubated wild ginseng root, characterized in that it comprises steps as follows:

(a) mixing ripen fruits and unripe fruits in a ratio of 80:20, washing them with water and completely removing any moisture to provide fruit ingredients, (b) transferring thus-prepared fruit ingredients to an air-tight sealed vessel, adding an alcoholic beverage having an alcohol concentration of 25-40% thereto, and carrying out fermentation under dark condition, (c) filtering the fermented liquor mash through a filtering membrane, and separating the filtrate into a liquor liquid and dregs using a press, (h) transferring the resulting liquor liquid to a storage tank, (i) adding the incubated wild ginseng root in an amount of 0.5-5 wt % during bottling process to a product which has been transferred to a product line in a stored state via pipe, followed by capping.

The present invention is characterized in that, said fruits can be at least one fruit pulps or extracts selected from a group consisting of Japanese apricot, tangerine, citron, wild grape, strawberry, fig, pomegranate, grape, banana, lemon, quince, cherry, peach, apple, apricot, cherry bob, summer tangerine, citron, prune, hardy-orange, pineapple, and wild berry. Further, it is characterized in that at least one selected from a group consisting of sucrose, fructose, glucose, honey, aspartame and stevioside is added as a sweetener.

Details of the method of preparing alcoholic beverages comprising incubated wild ginseng root according to the present invention include, as a result of continuous experiments and studies by the inventors of the present invention, pharmaceutically effective components of the incubated wild ginseng root are efficiently extracted in a fermented fruit liquor and a method for producing the fruit liquor having an optimized composition for obtaining a good balance of the taste and flavor between the incubated wild ginseng root and the fruit liquor itself is established, wherein said method is accompanied with the best process and conditions for incorporating the incubated wild ginseng root. As a result, the method of the present invention is characterized in that, the incubated wild ginseng root is added during a bottling process in an optimized state and an amount to a liquor liquid, which has been obtained by the best fermentation process for preparing fruit liquor and by filtration of the resulting liquor.

With respect to the efficacy of wild ginseng, it has been long recognized in oriental herbal medicine during last thousand years that wild ginseng has an excellent pharmaceutical effect. According to Dohongkyong (A.D. 488-496) who rewrote “Shin Nongbonshokyong”, an ancient oriental medicine book, it is described that “[W]ild ginseng helps to strengthen major human organs, stabilizes human spirit, helps to avoid sudden frightening, provides good eyesight, makes people think wiser, and helps to increase people's life expectancy.” According to the present invention, the incubated wild ginseng root is prepared as follows: obtaining one hundred and ten year old wild ginseng→carrying out a cellular division of the wild ginseng tissue→selecting a well-incubated ginseng root→growing the incubated root→carrying out the mass-production of the incubated root→harvesting the root→obtaining the final incubated root product after drying process. To fruit liquor, the incubated wild ginseng root is added in an amount of 0.5-5 wt %, preferably 2-3 wt %. When it is added below than said range, efficacy and flavor that are specific to wild ginseng cannot be obtained. On the other hand, when it is added more than said range, bitter taste coming from the wild ginseng root can block fruit liquor's own flavor. Meanwhile, according to the present invention, the incubated wild ginseng root is added to fruit liquor which has been obtained after the final fine filtration process, followed by immediate capping for bottling. As a result, it is expected that, an additional contamination can be prevented and the incubated wild ginseng root can be homogeneously extracted into the fruit liquor during a subsequent period for maturing and distributional process.

When ripen and unripe fruits are used in a mixing ratio of 80:20, flavor and taste of final fruit liquor becomes more balanced. Further, during a subsequent period for maturing and distributional process after the addition of the incubated wild ginseng root, it may achieve an effect that the flavors specific to fruit liquor and the incubated wild ginseng root, respectively, are synergistically enhanced.

By using fruit liquor having 25-40% alcohol content, preferably 30-35% alcohol content, fruit liquor product having a well-balanced flavor and taste can be obtained. Especially, during a period for adding the incubated wild ginseng root and subsequent maturing and distributional process, the flavors specific to fruit liquor and the incubated wild ginseng root, respectively, are synergistically enhanced.

By filtering the fermented liquor mash through a filtering membrane, separating it into a liquor liquid and dregs using a press, transferring the resulting liquor liquid to a storage tank, and adding the incubated wild ginseng root in an amount of 0.5-5 wt %, preferably 2-3 wt %, during bottling process to a product which has been transferred to a product line in stored state via pipe, followed by capping, a grape fruit liquor comprising the incubated wild ginseng root is produced according to the present invention. As a result, balancing of the flavors between the wild ginseng and fruit liquor can be obtained while the flavor of the incubated wild ginseng root is not blocked by the unpleasant flavor and taste coming from the residuals remained in fruit liquor.

Fruits that are used for preparing fruit liquor of the present invention are fresh and unscratched ones. They are prepared with clean washing and complete drying of moisture. Fruits are sometimes allowed to get dried overnight at cool place. Fruit seeds and peels are removed depending on types of the fruit used. For example, seeds are not removed from small fruits such as grape, prune and Japanese apricot when they are used as a whole. However, when the fruits are cut before being used (e.g., apple, lemon or orange, etc.), it is generally preferred to have the seeds removed. For producing liquor from fruits, a certain period for fermentation is required. A fermentation vessel should be sealed air-tight and kept under the shade in order to avoid any loss of color or taste of liquor. For hard fruits such as Japanese apricot, it is preferable to have it left in the liquor even after maturation. However, for other fruits having soft pulps such as grape or prune, the fruits become mashed with time, making the liquor turbid. Thus, such fruits are removed from the liquor after the maturation, followed by final filtration. When sugars such as sucrose are added to the liquor together with alcoholic beverages, they are not easily dissolved. Therefore, they are mixed with fruit ingredients first and then matured at room temperature for one to two weeks to obtain uniquely flavored liquor.

According to one embodiment of the present invention, a method of preparing alcoholic beverages comprising incubated wild ginseng root is provided, said method is characterized in that it comprises steps as follows:
(a) pre-treating alcoholic raw materials comprising a step of polishing and steaming brown rice,
(b) preparing koji fermentation liquid by propagating koji-molds in the steamed rice,
(c) producing crude liquor by scale-up propagation of yeast for liquor mash fermentation and further incubating the resulting liquor,
(d) additionally immersing the koji, water and the steamed rice to the crude liquor and fermenting it,
(e) filtering and preparing the liquor mash after the fermentation,
(f) heating the liquor liquid to remove aggregates and to sterilize the microorganisms,
(g) maturing the liquor liquid,
(h) subjecting the matured liquor liquid to a fine filtration process and transferring it to a storage tank, and
(i) adding the incubated wild ginseng root in an amount of 0.5-5 wt % during bottling process to a product which has been transferred to a product line in a stored state via pipe, followed by capping.

More specifically, the present invention relates to a method of preparing alcoholic beverages comprising incubated wild ginseng root, which is characterized in that it comprises steps as follows:
(a) pre-treating alcoholic raw materials comprising steps of polishing brown rice to the polishing level of 72-73%, washing and immersing the polished rice in water for 2 to 10 hrs, and steaming the rice for 10 to 22 min,
(b) propagating Aspergillus in the steamed rice at 25° C. for 38 to 42 hrs to prepare koji fermentation liquor,
(c) producing crude liquor by scale-up propagation of yeast for liquor mash fermentation and further incubating the resulting liquor at 25° C. for three days,
(d) additionally immersing the koji (22 kg), water (100 liter) and the steamed rice to the crude liquor (7.5 kg) to obtain the final weight of the steamed rice to be 100 kg and fermenting them at 7-15° C. for 15 to 20 days,
(e) filtering the fermented liquor mash through a filtering membrane and separating it into a liquor liquid and dregs using a press, followed by a removal of fine particles from the liquor liquid by using activated charcoals,
(f) heating the separated transparent liquor at the temperature of 55-60° C. to remove aggregates and to sterilize the microorganisms,
(g) maturing the liquor liquid for two to three months,
(h) subjecting the matured liquor liquid to a fine filtration process and transferring it to a storage tank, and
(i) adding the incubated wild ginseng root in an amount of 2-3 wt % during bottling process to a product which has been transferred to a product line in a stored state via pipe, followed by capping.

In addition, during the step (d) above, 2.4 liters of 30% alcoholic raw materials can be preferably added to 1 kg of the total rice weight. By appropriately adjusting an alcoholic amount, fermentation processes can be simplified and also various rice wines having different flavor and taste (e.g., drier taste) can be obtained.

For preparing rice wine according to the present invention, an additive which is used in a minor amount can be added and said additive is at least one selected from a group consisting of aspartame, stevioside, citric acid and amino acid.

Details of the method of preparing rice wine comprising incubated wild ginseng root according to the present invention include that, as a result of continuous experiments and studies by the inventors of the present invention, pharmaceutically effective components of the incubated wild ginseng root are efficiently extracted into a fermented liquor and a method for producing the rice wine having an optimized composition for obtaining a good balance of the taste and flavor between the incubated wild ginseng root and the rice wine itself is established, wherein said method is accompanied with the best process and conditions for incorporating the incubated wild ginseng root.

Therefore, according to the present invention, functional rice wine is prepared by adding the incubated wild ginseng root under optimized condition with the best method for preparing rice wine. In other words, the present invention is characterized in that the incubated wild ginseng root is added in an optimized state and an amount during a bottling process to a liquor liquid, which has been obtained after a serial processes including the optimum pre-treatment, treatment with koji mold, preparation of crude liquor, immersion of the ingredients, fermentation of the liquor, treatment with koji mold, maturation and filtration of the liquor.

According to the present invention, the incubated wild ginseng root is prepared as follows: obtaining one hundred and ten year old wild ginseng→carrying out a cellular division of the wild ginseng tissue selecting a well-incubated ginseng root→growing the incubated root→carrying out the mass-production of the incubated root→harvesting the root→obtaining the final incubated root product after drying process. To rice wine, the incubated wild ginseng root is added in an amount of 0.5-5 wt %, preferably 2-3 wt %. When it is added below than said range, efficacy and flavor that are specific to wild ginseng cannot be obtained. On the other hand, when it is added more than said range, bitter taste coming from the wild ginseng root can block rice wine's own flavor. Meanwhile, according to the present invention, the incubated wild ginseng root is added to the rice wine which has been obtained after the final fine filtration process, followed by immediate capping for bottling. As a result, it is expected that, an additional contamination can be prevented and the incubated wild ginseng root can be homogeneously extracted into the rice wine during a subsequent period for maturing and distributional process.

When washed rice is immersed in water less than two hours, moistures that are insufficient for rice steaming are absorbed by rice. When it is immersed in water more than ten hours, the rice can be too mushy. In order to saccharize the starchy components of rice, Aspergillus oryzae or Aspergillus niger, both belong to yellow koji molds (i.e., Aspergillus), and typically used for producing rice wine, can be used. However, other kinds of microorganism can be also used. In accordance with rice steaming process, propagation of koji-molds can be facilitated and the enzymatic process can be also promoted. By koji-fermentation process, Aspergillus is propagated over hard cooked rice to prepare koji molds that are required for producing rice wine. This saccharizing process can give liquor the flavor that is unique to traditional liquor, and the contamination of liquor can be avoided at the same time. The crude liquor herein refers to yeast culture that has been obtained by scale-up propagation for maintaining the fermentation of liquor mash.

By heating the separated liquor liquid at the temperature of 55 to 60° C., the formed aggregates (e.g., starch, cellulose material and insoluble protein, etc.) are removed, the microorganisms are sterilized and the enzymes are destroyed. In addition, the flavor is matured and the incubated wild ginseng root is added to the matured liquor to give a harmonized flavor.

After the immersion process, fermentation is carried out slowly at the temperature of 7 to 15° C. for about 15 to 20 days. If the temperature is lower than 7° C., the fermentation becomes extremely slow and thus requires a very long fermentation time. On the other hand, if the temperature is higher than 15° C., the fermentation becomes extremely fast, resulting in rough taste of liquor. Especially, when the liquor has rough taste, a balance with the flavor of the incubated wild ginseng root may not be obtained.

According the present invention, the incubated wild ginseng root is at least one selected from a group consisting of fresh root of incubated wild ginseng, dried powder of the incubated root, pill containing the incubated root, extract of the incubated root, concentrate of the incubated root and dried granule comprising the incubated root.

Alcoholic beverages used in the present invention include distilled liquor, soju, whiskey, brandy, beer, rice wine, rice liquor, fruit liquor, and liquor, etc., but are not limited thereto.

In order to achieve another purpose of the present invention, an alcoholic beverage comprising the incubated wild ginseng root, that has been produced by the above-described method for preparing alcoholic beverages of the present invention, is provided.

The present invention will now be described in greater detail with reference to the following examples. However, it is only to specifically exemplify the present invention and in no case the scope of the present invention is limited by these examples.

### EXAMPLE

### Example 1

### Fruit Liquor

### Example 1a

Ripen grapes and unripe grapes were mixed in a ratio of 80:20, and then washed with water. After removing all the moisture, grapes were ready to use. Thus-prepared grapes (1 kg) were put into an air-tight sealed vessel, an alcoholic material having an alcohol concentration of 30% was added thereto (2.5 L), and fermentation was carried out at cool and dark place for six months. Following the completion of the fermentation, the fermented liquor mash was filtered through a filtering membrane, and separated into a liquor liquid and dregs using a press. The resulting liquor liquid was then transferred to a storage tank. Then, the incubated wild ginseng root in an amount of 2 wt % was added during bottling process to said liquor product which has been transferred to a product line in a stored state via pipe, followed by capping, providing grape liquor comprising the incubated wild ginseng root. Meanwhile, for the incubated wild ginseng root, those having the same components as the wild ginseng developed by CBN biotech but with better efficacy were used.

### Example 1b

Grape fruit liquor comprising the incubated wild ginseng root was prepared with the same method as described in above Example 1a, except that sucrose was added to the grapes (i.e., 2 wt % compared to the grapes), the liquor was matured for one day and then fermented during the preparation step of Example 1a.

### Example 1c

Ripen Japanese apricots and unripe green Japanese apricots were mixed in a ratio of 80:20, and then washed with water. After removing all the moisture, Japanese apricots were ready to use. Thus-prepared Japanese apricots (1 kg) were put into an air-tight sealed vessel, an alcoholic material having an alcohol concentration of 30% was added thereto (2.5 L), and fermentation was carried out at cool and dark place for six months. Following the completion of the fermentation, the fermented liquor mash was filtered through a filtering membrane, and separated into a liquor liquid and dregs using a press. The resulting liquor liquid was then transferred to a storage tank. Then, the incubated wild ginseng root in an amount of 2 wt % was added during bottling process to said liquor product which has been transferred to a product line in a stored state via pipe, followed by capping, providing Japanese apricot liquor comprising the incubated wild ginseng root.

### Example 1d

Japanese apricot liquor comprising the incubated wild ginseng root was prepared with the same method as described in above Example 1c, except that honey was added to the Japanese apricots (i.e., 2 wt % compared to the Japanese apricots), the liquor was matured for one day and then fermented during the preparation step of Example 1c.

### Example 1e

Ripen citrons and unripe citrons were mixed in a ratio of 80:20, and then washed with water. After removing all the moisture, citrons were ready to use. Thus-prepared citrons (1 kg) were put into an air-tight sealed vessel, an alcoholic material having an alcohol concentration of 30% was added thereto (2.5 L), and fermentation was carried out at cool and dark place for six months. Following the completion of the fermentation, the fermented liquor mash was filtered through a filtering membrane, and separated into a liquor liquid and dregs using a press. The resulting liquor liquid was then transferred to a storage tank. Then, the incubated wild ginseng root in an amount of 2 wt % was added during bottling process to said liquor product which has been transferred to a product line in a stored state via pipe, followed by capping, providing citron liquor comprising the incubated wild ginseng root.

### Example 1f

Citron liquor comprising the incubated wild ginseng root was prepared with the same method as described in above Example 1e, except that sucrose was added to the chopped citrons (i.e., 2 wt % compared to the citrons), the liquor was matured for two days and then fermented during the preparation step of Example 1e.

### <Sensory Test>

The fruit liquor comprising the incubated wild ginseng root, which had been obtained from the above-described Examples 1a to 1f (i.e., grape, Japanese apricot, and citron fruit liquor), was further matured for about a week, and then compared with grape wine (Comparative example 1), Japanese apricot liquor (Comparative example 2), and citron liquor (Comparative example 3), that are all prepared by conventional methods without adding any incubated wild ginseng root. Twenty panelists trained for sensory test were employed for the sensory test of the present invention. All the tests were carried out in triplicate. Results are summarized in the following Table 1. Specifically, the panelists evaluated each liquor in terms of taste, flavor, color and overall likeness. The sensory rating was done based on score level 1 to 5 (i.e., 5 is the highest score). The panelists gave the scores on the basis of following scoring criteria. Results of Table 1 show the average value.

5: Very good

### 4: Good

### 3: Average

2: Not good or bad

### 1: Very bad

TABLE 1

| | Taste | Flavor | Color | Overall likeness |
|---|---|---|---|---|
| Comparative example 1 | 3.8 | 3.7 | 3.5 | 3.6 |
| Example 1a | 4.2 | 4.0 | 3.5 | 4.2 |
| Example 1b | 4.3 | 4.0 | 3.5 | 4.3 |

As it is described in above Table 1, the grape liquor comprising the incubated wild ginseng root which had been prepared according to the example of the present invention shows better sensory scores in terms of taste and flavor compared to a conventional grape wine, regardless of the presence or absence of sucrose. Color was not so much different between the liquor of the present invention and the conventional liquor. Consequently, the grape liquor comprising the incubated wild ginseng root which had been prepared according to the example of the present invention shows much better overall likeness score compared to the conventional liquor. According to sensory property description, again the panelists said that the grape liquor comprising the incubated wild ginseng root which had been prepared according to the example of the present invention has a harmonious taste and flavor resulting from an integration of those of the wine liquor and the incubated wild ginseng root, providing much smoother and cleaner than the liquor of the comparative example.

TABLE 2

| | Taste | Flavor | Color | Overall likeness |
|---|---|---|---|---|
| Comparative example 2 | 3.5 | 3.3 | 3.5 | 3.3 |
| Example 1c | 3.7 | 3.7 | 3.6 | 3.6 |
| Example 1d | 3.8 | 3.8 | 3.5 | 3.7 |

As it is described in above Table 2, Japanese apricot liquor comprising the incubated wild ginseng root which had been prepared according to the example of the present invention shows better sensory scores in terms of taste and flavor compared to a conventional Japanese apricot liquor, regardless of the presence or absence of honey. Color was not so much different between the liquor of the present invention and the conventional liquor. Consequently, the Japanese apricot liquor comprising the incubated wild ginseng root which had been prepared according to the example of the present invention shows much better overall likeness score compared to the conventional liquor. According to sensory property description, again the panelists said that the Japanese apricot liquor comprising the incubated wild ginseng root which had been prepared according to the example of the present invention has a harmonious taste and flavor resulting from an integration of those of the Japanese apricot liquor and the incubated wild ginseng root, providing much smoother and cleaner than the liquor of the comparative example.

TABLE 3

| | Taste | Flavor | Color | Overall likeness |
|---|---|---|---|---|
| Comparative example 3 | 3.1 | 2.9 | 3.1 | 3.1 |
| Example 1e | 3.5 | 3.5 | 3.3 | 3.3 |
| Example 1f | 3.6 | 3.6 | 3.1 | 3.4 |

As it is described in above Table 3, citron liquor comprising the incubated wild ginseng root which had been prepared according to the example of the present invention shows better sensory scores in terms of taste and flavor compared to a conventional citron liquor, regardless of the presence or absence of sucrose. Color was not so much different between the liquor of the present invention and the conventional liquor. Consequently, the citron liquor comprising the incubated wild ginseng root which had been prepared according to the example of the present invention shows much better overall likeness score compared to the conventional liquor. According to sensory property description, again the panelists said again the citron liquor comprising the incubated wild ginseng root which had been prepared according to the example of the present invention has a harmonious taste and flavor resulting from an integration of those of the citron liquor and the incubated wild ginseng root, providing much smoother and cleaner than the liquor of the comparative example.

### Example 2

### Rice Wine

### Example 2a

Brown rice having relatively high content of starch was used as a raw rice material. Polishing was carried out to the polishing level of 73% to yield white rice. Bran stuck on the rice was removed, the rice was washed with water three times, and then immersed in water for about two hours. Then, the rice was steamed for 18 minutes and pregelatinized to obtain hard-cooked rice. To the resulting hard-cooked rice, Aspergillus was propagated at 25° C. for 40 hours to give a high quality koji (i.e., koji-mold). To carry out fermentation of liquor mash, yeast was subjected to scale-up propagation at 25° C. for three days to prepare crude liquor. To thus-prepared crude liquor (7.5 kg), the koji prepared above (22 kg), the steamed rice prepared above (100 kg), and water (100 liter) were sequentially immersed in a tank. Fermentation was carried out at 15° C. for eighteen days.

The fermented liquor mash was filtered through a filtering membrane (pore size 0.45 μm) and separated into a liquor liquid and dregs using a multi-level press. The liquor liquid which had been homogeneously mixed in a mixing tank was treated with activated charcoals to remove fine particles, and then the separated transparent liquor liquid was heated at the temperature of 60° C. to remove aggregates and to sterilize the microorganisms. The liquor liquid was then matured approximately for two months. The matured crude liquid was subjected to a fine filtration process to remove fine particles and/or precipitates and stored in a storage tank. Finally, the incubated wild ginseng root in an amount of 2 wt % was added during bottling process to a liquor product which had been transferred to a product line in a stored state via pipe, followed by capping, to provide rice wine comprising the incubated wild ginseng root.

Meanwhile, for the incubated wild ginseng root, those having the same components as the wild ginseng developed by CBN biotech but with better efficacy were used. After obtained from Yonchon Unrefined Rice Liquor Company, Aspergillus kawachii was propagated for two days and then used. Commercially available yeast was used for the present invention.

### Example 2b

Rice wine comprising the incubated wild ginseng root was prepared with the same method as described in above Example 2a, except that 30% alcoholic material (i.e., 2.4 liters per 1 kg of total rice) was added to the liquor after the immersion and fermentation processes during the preparation step of Example 2a.

### Example 2c

Rice wine comprising the incubated wild ginseng root was prepared with the same method as described in above Example 2a, except that aspartame (i.e., 0.2 wt %) was added to the liquor after the immersion and fermentation processes during the preparation step of Example 2a.

### Example 2d

Rice wine comprising the incubated wild ginseng root was prepared with the same method as described in above Example 2a, except that citric acid (i.e., 0.2 wt %) was added to the liquor after the immersion and fermentation processes during the preparation step of Example 2a.

### <Sensory Test>

The rice wine comprising the incubated wild ginseng root, which had been obtained from the above-described Examples 2a to 2d, was further matured for about a week, and then compared with a commercial rice wine of which alcohol amount has been adjusted to be the same as that of the present invention (Comparative example 4). Twenty panelists trained for sensory test were employed for the sensory test of the present invention. All the tests were carried out in triplicate. Results are summarized in the following Table 4. Specifically, the panelists evaluated each liquor in terms of taste, flavor, color and overall likeness. The sensory rating was done based on score level 1 to 5 (i.e., 5 is the highest score). The panelists gave the scores on the basis of following scoring criteria. Results of Table 1 show the average value.

5: Very good

### 4: Good

### 3: Average

2: Not good or bad

### 1: Very bad

TABLE 4

| | Taste | Flavor | Color | Overall likeness |
|---|---|---|---|---|
| Comparative example 4 | 3.1 | 2.9 | 3.1 | 3.1 |
| Example 2a | 3.7 | 3.7 | 3.6 | 3.6 |
| Example 2b | 3.8 | 4.0 | 3.6 | 3.8 |
| Example 2c | 3.4 | 3.8 | 3.6 | 3.6 |
| Example 2d | 3.8 | 3.8 | 3.6 | 3.8 |

As it is described in above Table 4, rice wine comprising the incubated wild ginseng root which had been prepared according to the example of the present invention shows better sensory scores in terms of taste and flavor compared to a conventional rice wine, regardless of the presence or absence of minor additives. Color was also better for the rice wine of the present invention compared to comparative example 4. According to an analysis using a calorimeter, the rice wine of the present invention showed better redness (a) and yellowness (b) than comparative example 4, indicating that the pigment components that are unique to the incubated wild type ginseng had been extracted into the rice wine of the present invention. Consequently, the rice wine comprising the incubated wild ginseng root which had been prepared according to the example of the present invention shows much better overall likeness score compared to the rice wine of comparative example 4. According to sensory property description, again the panelists said that the rice wine comprising the incubated wild ginseng root which had been prepared according to the example of the present invention has a harmonious taste and flavor resulting from an integration of those of the rice wine and the incubated wild ginseng root, providing much smoother and better than the liquor of the comparative example 4. In addition, when an alcoholic material (seasoned soju) had been complemented after the fermentation process of Example 2b, many panelists indicated that liquor taste became even cleaner.

### Example 3

### Liquor

A method of preparing liquor comprising the incubated wild ginseng root is characterized in that it comprises steps as follows:

(a) the incubated wild ginseng root is extracted for one to three months with 40-45% alcoholic material which has been obtained after the deodorizing process, (b) the wild ginseng root after said extraction is separated and stored separately, (c) the alcoholic extract from which the incubated wild ginseng root has been removed is matured for one to three months, followed by filtration, (d) the matured alcoholic liquid which comprises the extract of the incubated wild ginseng root is diluted to have an alcohol concentration of 20-25% and then subjected to a fine-filtration, (e) the incubated wild ginseng root, that had been set aside in above step (b), is added to said diluted alcoholic liquid during bottling process, followed by air-tight sealing and packaging. The present invention is characterized in that, in order to produce generally a product in a form of liquor, to the diluted alcoholic liquid comprising the extract of the incubated wild ginseng root at said step (d) an additive such as sucrose, oligosaccharides, honey, citric acid and amino acid, etc. is further added. The liquor as prepared above can be applied for preparing alcoholic beverage products in various forms.

### Example 4

### Rice Liquor

A method of preparing rice liquor to which the incubated wild ginseng root is added comprises the steps as follows:

(a) treating raw materials for preparing alcoholic materials, comprising steps of washing starch materials for preparing alcoholic materials, such as rice, potato or yam, immersing them in a liquid, removing water, and propagating them (Step R1), (b) preparing koji fermentation liquid by propagating Aspergillus kawachii in steamed rice for two days (Step R2), (c) preparing crude liquor by which yeast was subjected to scale-up propagation for achieving the fermentation of liquor mash (Step R3), (d) carrying out first-level immersion in which crude liquor is further fermented at 23-27° C. for 2-5 days to ferment the yeast (Step R4), (e) carrying out second-level immersion for the materials of first-level immersion by adding additional rice, water, and fermenting agent and fermenting them at 25° C. for 7-8 days in order to ferment the alcoholic materials (Step R5), (f) filtering the liquor through a membrane having 0.45 μm pore size using a filtering bag (Step R6), (g) pressing the liquor with a multi-level press (Step R7), (h) blending in aspartame, stevioside, citric acid and amino acid (Step R8), (i) removing fine particles from the rice liquor, which has been homogeneously mixed in a mixing tank, using activated charcoals based on fined filtration process (Step R9), followed by transferring the liquor to a storage tank, (j) adding the incubated wild ginseng root in an amount of 2-3 wt % during bottling process to a product which has been transferred to a product line in a stored state via pipe (Step R10), and (k) producing a final liquor product by bottling and capping processes (Step R11 and Step R12).

As a raw ingredient for preparing alcoholic materials, starchy materials, sugar materials or their mixture are subjected first to a saccharizing process by fermentation and then prepared by following continuous distillation. To saccharize a starchy material, Aspergillus kawachii, which belongs to white koji-molds and usually used for producing rice wine or unrefined rice wine, is used in the present invention. Since white koji-molds have a very slow growth at 30-33° C., which is the initial temperature for propagation, it is highly unlikely that the white koji-molds contaminate yellow koji molds, i.e., Aspergillus. By the koji-fermentation process, starches are saccharized and flavor that is unique to traditional liquor can be given to the liquor to be prepared. Further, contamination of liquor mash can be avoided. The crude liquor herein refers to yeast culture that has been obtained by scale-up propagation for maintaining the fermentation of liquor mash.

### EFFECT OF THE INVENTION

As described above, the present invention relates to a novel functional alcoholic beverages having higher values added to existing alcoholic beverages by using a natural material, in order to satisfy consumer's desire for health and functional food products in future food industries. Specifically, pharmaceutical components obtained from the incubated wild ginseng root, which has the same genetic composition and even better efficacy than wild ginseng, are added to various type of alcoholic beverages so that they can be taken with alcohols by consumers. As a result, the pharmaceutical components of wild ginseng can work along with an alcohol metabolism in human bodies to provide an excellent effect of the wild ginseng such as reducing hangover after drinking, etc. In addition, thanks to unique flavor of the incubated wild ginseng root that is delivered to a consumer when he or she drinks the alcoholic beverages of the present invention, hangover resulting from alcohol drinking can be reduced. Thus, the present invention is to provide functional alcoholic beverages having deep taste and flavor unique to the incubated wild ginseng root, and therefore they are easy and smooth to drink. Further, since the incubated wild ginseng root itself is put into a bottle of the alcoholic beverage, it is possible to obtain public confidence and to give a consumer an opportunity to recycle.

What is claimed:

1. A method of preparing alcoholic beverages comprising incubated wild ginseng root, characterized in that it comprises a step of adding the incubated wild ginseng root in an amount of 0.5-5 wt % during bottling process, followed by capping.

2. The method of preparing alcoholic beverages comprising incubated wild ginseng root according to claim 1, characterized in that it comprises steps as follows: mixing ripen fruits and unripe fruits in a ratio of 80:20; fermenting the fruits with an alcoholic beverage having an alcohol concentration of 30-35% in an air-tight sealed vessel; separating the fermented liquor mash into a liquor liquid and dregs, and; adding the incubated wild ginseng root in an amount of 0.5-5 wt % to said liquor liquid during bottling process, followed by capping.

3. The method of preparing alcoholic beverages comprising incubated wild ginseng root according to claim 1, characterized in that it comprises steps as follows:
(a) pre-treating alcoholic raw materials comprising a step of polishing and steaming brown rice,
(b) preparing koji fermentation liquid by propagating koji-molds in the steamed rice,
(c) producing crude liquor by scale-up propagation of yeast for liquor mash fermentation and further incubating the resulting liquor,
(d) additionally immersing the koji, water and the steamed rice to the crude liquor and fermenting it,
(e) filtering and preparing the liquor mash after the fermentation,
(f) heating the liquor liquid to remove aggregates and to sterilize the microorganisms,
(g) maturing the liquor liquid,
(h) subjecting the matured liquor liquid to a fine filtration process and transferring it to a storage tank, and
(i) adding the incubated wild ginseng root in an amount of 0.5-5 wt % during bottling process to a product which has been transferred to a product line in a stored state via pipe, followed by capping.

4. The method of preparing alcoholic beverages comprising incubated wild ginseng root according to claim 3, characterized in that it comprises steps as follows:
(a) pre-treating alcoholic raw materials comprising steps of polishing brown rice to the polishing level of 72-73%, washing and immersing the polished rice in water for 2 to 10 hrs, and steaming the rice for 10 to 22 min,
(b) propagating Aspergillus in the steamed rice at 25° C. for 38 to 42 hrs to prepare koji fermentation liquor,
(c) producing crude liquor by scale-up propagation of yeast for liquor mash fermentation and further incubating the resulting liquor at 25° C. for three days,
(d) additionally immersing the koji (22 kg), water (100 liter) and the steamed rice to the crude liquor (7.5 kg) to obtain the final weight of the steamed rice to be 100 kg and fermenting them at 7-15° C. for 15 to 20 days,
(e) filtering the fermented liquor mash through a filtering membrane and separating it into a liquor liquid and dregs using a press, followed by a removal of fine particles from the liquor liquid by using activated charcoals,
(f) heating the separated transparent liquor liquid at the temperature of 55-60° C. to remove aggregates and to sterilize the microorganisms,
(g) maturing the liquor liquid for two to three months,
(h) subjecting the matured liquor liquid to a fine filtration process and transferring it to a storage tank, and
(i) adding the incubated wild ginseng root in an amount of 2-3 wt % during bottling process to a product which has been transferred to a product line in a stored state via pipe, followed by capping.

5. The method of preparing alcoholic beverages comprising incubated wild ginseng root according to claim 1, characterized in that the incubated wild ginseng root is at least one selected from a group consisting of fresh root of incubated wild ginseng, dried powder of the incubated root, pill containing the incubated root, extract of the incubated root, concentrate of the incubated root and dried granule comprising the incubated root.

6. The method of preparing alcoholic beverages comprising incubated wild ginseng root according to claim 1, characterized in that the alcoholic beverages are selected from a group consisting of distilled liquor, soju, whiskey, brandy, beer, rice wine, rice liquor, fruit liquor, and liquor.

7. Alcoholic beverage produced by a method according to claim 1.

8. Alcoholic beverage produced by a method according to claim 2.

9. Alcoholic beverage produced by a method according to claim 3.

10. Alcoholic beverage produced by a method according to claim 4.

11. Alcoholic beverage produced by a method according to claim 5.

12. Alcoholic beverage produced by a method according to claim 6.
